(19) United States
(12) Patent Application Publication
(10) Pub. No.: US 2004/0012572 A1
(43) Pub. Date: Jan. 22, 2004

(54) Display and touch screen method and apparatus

(76) Inventors: Anthony Sowden, Bristol (GB); James J. Girard, Boise (ID)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/388,757

(22) Filed: Mar. 17, 2003

(30) Foreign Application Priority Data
Mar. 16, 2002 (GB) 0206237.0

(51) Int. Cl. G09G 5/00

(52) U.S. Cl. 345/173

(57) ABSTRACT

A user interface for a portable hand held electronic computer comprises a display for displaying plural display icons and/or menus. A pressure sensitive surface surrounds the display area such that the pressure sensitive surface does not overlay the display area. The computer controls the pressure sensitive area so the same region of the area has different functions.

### FIELD OF THE INVENTION

The present invention relates to the field of human interfaces for computer entities, and particularly to an interface having a display screen and a touch sensitive surface.

### BACKGROUND TO THE INVENTION

Modern user interfaces for computer devices generally fall in to three categories. A first type of user interface used in known personal computers (PC's) makes use of a visual display screen and a pointing device, for example a mouse or track-ball device, manipulation of which moves a pointer icon on the screen and allows selection of functions by selection of icons or menu items as is well known.

A second type of known user interface, also used in known personal computers, comprises an external keypad, for example a QWERTY keypad, whereby text commands are typed, which are shown up on a monitor screen.

A third type of user interface comprises a touch-sensitive screen display, whereby graphics, text or icons are displayed on a display device, which is overlaid by a touch sensitive screen. The touch sensitive screen can be operated either by manual contact, such as by pressing a finger over an icon, or by use of a pen type device having a transmitter or transponder incorporated in it. For small portable electronic devices, indirect pointing devices (mouse, track-ball, etc.) are not favored due to requirements of portability, and the requirement for a relatively small device. Touch screens operated by a finger or a pen device are a popular option and are well known in- portable personal digital assistant (PDA) type devices such as available from Hewlett Packard Company, Compaq and other vendors.

Electronic books (E-Books) are a relatively new category of prior art portable device. Particular problems which occur for electronic books include the basic readability of the electronic book and designing an effective user interface which does not compromise on the portability or the readability of an electronic book.

The specific requirements for readability and usability of electronic books and portable computers has prompted the inventors to consider developing a user interface which will improve the human-machine interfaces for such devices. Specific examples of prior art technology available for a user interface for an electronic book include the following:

Referring to FIG. 1 herein, there is illustrated schematically a prior art device of the hand held computer type, available, e.g., from Compaq or Hewlett Packard Co. Examples of this type of device are numerous. The device comprises an external casing 100 having a touch sensitive display screen 101. A surface area of the casing 100 surrounding the display screen is provided with a plurality of push button switches 102, for selecting different modes of operation presented on the screen. Functions of the screen can be activated by pressing a finger or stylus against a plurality of icons 103 displayed on the screen. Additionally, there is provided a touch sensitive area 104 comprising a “scribble” area 105, which can be used for testing a pen device or testing the operation of the touch sensitive screen; and placed around the scribble area, a plurality of printed touch sensitive icons 106, for selecting different modes of operation, and different displays of the display area.

Referring to FIG. 2 herein there is illustrated schematically in cut-away view, a conventional touch screen of a hand held computer device. The touch screen comprises a display screen comprising first substrate layer 200, for example a liquid crystal display screen, overlaid by a second pressure sensitive layer 201.

Referring to FIG. 3. herein, the pressure sensitive layer comprises a mesh of a plurality of fine electrical conductors 300 arranged in orthogonal rows and columns, embedded in a clear polymer layer 301. Pressing the polymer layer causes electrical contact between individual horizontal and vertical conductors at a position where pressure is applied to the screen. Fabrication of touch sensitive screens is well known to those skilled in the art.

However, known touch sensitive screens have a problem in viewing the screen, since external light is reflected from an external surface of the polymer layer, causing glare and light transmitted from the underlying display screen layer to be attenuated and reflected by the touch sensitive polymer layer internally back into the display screen layer, sometimes making viewing of the screen difficult. Therefore, although the display layer 200 usually has low reflectivity and is easy to view, addition of the touch sensitive layer introduces high reflectivity and sometimes makes the composite screen difficult to read. Touch screens would potentially be very useful in an electronic book product since they provide very intuitive ways of entering instructions into a computer device. However, conventional touch screens are sometimes undesirable for electronic books, because of the serious problem of reflectivity and glare.

Levels of performance of conventional touch screens are adequate for conventional hand-held computer devices, where users are not reading from the screen to a high degree. However, for an electronic book, the primary purpose of which is to read from, screen reflections are a serious disadvantage and are detrimental to the usability of the device. The basic problem of poor usability of electronic books is one issue restricting acceptance of such devices by consumers.

One possible solution to providing a low reflectivity touch screen is to have a position sensitive layer underneath a display screen layer. This is possible by using a separate pointing device, such as a pen or stylus device, which distorts an electromagnetic field generated by the position sensitive layer, and which the position sensitive layer can detect when the pen device is near the screen. However, using such screens, finger operation is not possible because human fingers do not distort the electromagnetic field in the same way as the pen device and use of the pen device is not as easy as finger touch operation.

### SUMMARY OF THE INVENTION

One object of specific embodiments according to the present invention is to provide an easy to use user interface having the flexibility of a multi-function display and a touch sensitive region, wherein displayed functions can be activated by touching a touch sensitive region, without the aid of a separate electronic pointing device.

Specific embodiments of the present invention provide a direct graphical user interface suitable for a portable computer device, similar to that offered by a conventional touch screen equipped device, but without the need for a conventional touch screen having the prior art problems of high reflectivity and glare.

In specific embodiments of the present invention a user interface provides a touch sensitive area adjacent to a display. The touch sensitive area can be one contiguous area or a number of adjacent touch sensitive areas. The touch sensitive area or areas can extend around a perimeter of the display.

The user interface indicates menu or icon options to a user using visual links on the display to point to areas of the touch sensitive area which perform particular functions.

In one embodiment, a touch sensitive area around a display is made up of a plurality of adjacent touch sensitive areas, each one of which can be activated independently. This allows a user to operate more than one touch sensitive area simultaneously and therefore operate more than one device function simultaneously and in parallel.

According to a first aspect of the present invention there is provided:

a user interface for a computer device, said user interface comprising:

a visual display for displaying a plurality of display items each representing a function of said computer device; and

a touch sensitive surface, said touch sensitive surface positioned relative to said display so as not to obscure a view of any of the display items on said display, said touch sensitive surface including a plurality of touch sensitive regions;

said touch sensitive regions and the computer device being arranged so the region can activate plural functions of said computer device represented by said display items.

According to a second aspect of the present invention there is provided:

a method of controlling operation of a computer device, said method comprising the steps of:

during a first time interval:

(a) displaying a first display item in a display region of a display;

(b) applying pressure to a pressure sensitive region of a pressure sensitive surface, said pressure sensitive region being positioned away from a position of said display region where said display item is displayed on said display screen, such that said pressure sensitive region does not overlay said display region where said display item is displayed;

(c) in response to said pressure applied during the first interval, activating a first function of said computer device, represented by said first display item;

during a second time interval:

(a) displaying a second display item in a display region of the display;

(b) applying pressure to the pressure sensitive region of the pressure sensitive surface, and

(c) in response to said pressure applied during the second interval, activating a second function of said computer device, represented by said second display item.

According to a third aspect of the present invention there is provided:

a user interface for a computer device, said user interface comprising:

a display area for displaying a plurality of display items each representing a corresponding function of said computer device;

the at least one pressure sensitive region corresponding with at least one of said display items, the at least one pressure sensitive region and the computer being arranged for generating plural signals having different functions in response to a pressure input at said pressure sensitive region;

wherein said pressure sensitive region is spaced apart from a region of said display area occupied by said display item, such that said pressure sensitive region does not overlay said display item.

According to a fourth aspect of the present invention there is provided:

a user interface for a computer device, said user interface comprising:

a substantially flat display having a plurality of display regions, each of said display regions being capable of being electronically activated to display plural display items having different functions; and

a touch sensitive surface, said touch sensitive surface being positioned immediately adjacent a visible area of said display device, said touch sensitive surface comprising at least one touch sensitive region, said touch sensitive region and computer device being arranged for generating plural signals having different functions in response to an applied touch;

wherein said touch sensitive region is spaced apart from a region of said display device occupied by a said display item, such that said touch sensitive region does not overlay said display item.

According to a fifth aspect of the present invention there is provided:

a computer device comprising:

a user interface comprising a display area for display a plurality of display items each representing a corresponding function of said computer entity, and a touch sensitive surface, said touch sensitive surface comprising at least one touch sensitive region, said touch sensitive surface and computer device being arranged for generating plural signals having different functions in response to a touch input applied at said touch sensitive region;

a display driver for driving display of said plurality of display items in said display area;

a touch interface driver for driving said touch sensitive surface; and

at least one controller for controlling said display area and said touch sensitive surface to generate a plurality of display items displayed on said display area and a plurality of touch sensitive regions generated on said touch sensitive surface wherein each said touch sensitive region provides plural functions corresponding with plural respective display items displayed on said display area.

### BRIEF DESCRIPTION OF THE DRAWING

For a better understanding of the invention and to show how the same can be carried into effect, there is now described by way of example only, specific embodiments, methods and processes according to the present invention with reference to the accompanying drawings in which:

FIG. 1, as previously described, is a perspective view of a prior art hand held computer device having a known touch sensitive display screen;

FIG. 2 is a schematic cut-away view of a display screen layer and an overlaid touch sensitive layer of the touch screen shown in FIG. 1;

FIG. 3 is a schematic diagram of the prior art pressure sensitive layer of the touch screen of FIGS. 1 and 2.

FIG. 4 is a front view of a user interface according to a first specific embodiment of the present invention, in a first display mode;

FIG. 5 is a front view of the user interface of FIG. 4, in a second mode of operation;

FIG. 6 is a schematic diagram of a pressure sensitive layer suitable in the device of FIG. 4 for detecting a one dimensional linear position;

FIG. 7 is a front view of the user interface of FIG. 4 in a third mode of 0operation;

FIG. 8 is a side sectional view of a first construction option for the user interface of FIG. 4;

FIG. 9 is a side sectional view of a second construction option for the user interface of FIG. 4; and

FIG. 10 is a block diagram of a controller and drive arrangement for an interface, according to a fourth specific embodiment of the present invention.

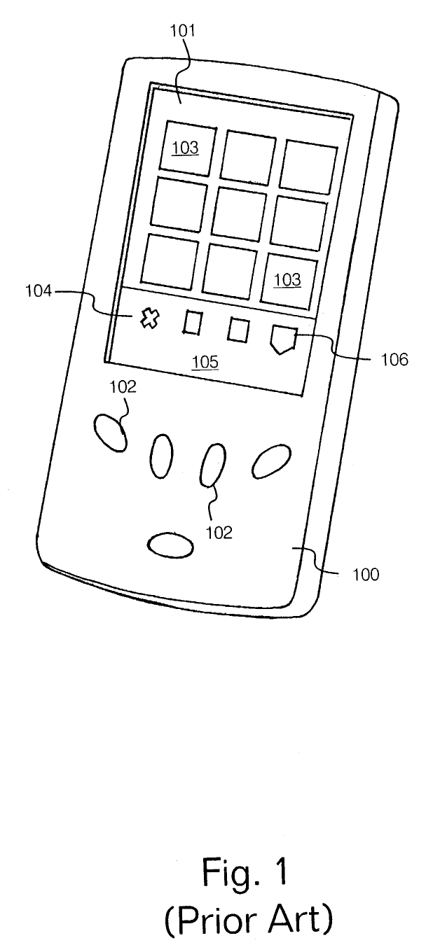

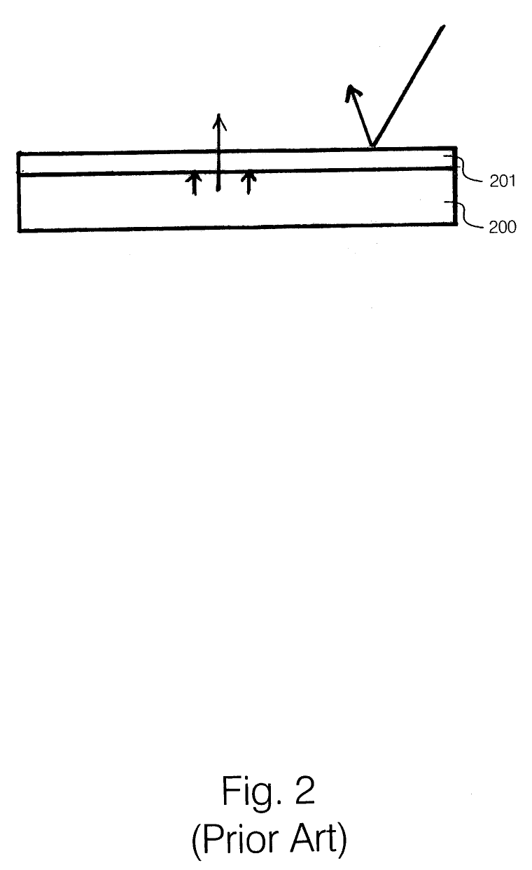

### DETAILED DESCRIPTION OF THE DRAWING

In the following description numerous specific details are set forth in order to provide a thorough understanding of the present invention. It will be apparent however, to one skilled in the art, that the present invention can be practiced without limitation to these specific details. In other instances, well known methods and structures have not been described in detail so as not to unnecessarily obscure the present disclosure.

In this specification, the term “touch sensitive region” means a region which can detect the presence of an electrically passive pointer, such pointers including for example a human finger, a wooden pencil, a plastic pen or pencil, a rubber or synthetic polymer eraser device, or like device of dimensions comparable to a human finger. The term includes a region which is sensitive to pressure applied by such a pointer device.

Specific embodiments according to the present invention comprise a display region, which is directly viewable and a touch sensitive region positioned adjacent to said viewable display region which is responsive to touch by a pointer. Display icons and/or graphics displayed in the display region direct a user to a corresponding area of the touch sensitive region. The display is operated under program control, such that different display modes can be effected. The touch sensitive region is configurable under program control such that different areas of the touch sensitive region can be re-assigned to perform different functions. Each different display mode can correspond to a different set of functions activated by touching different configurations of the touch sensitive region.

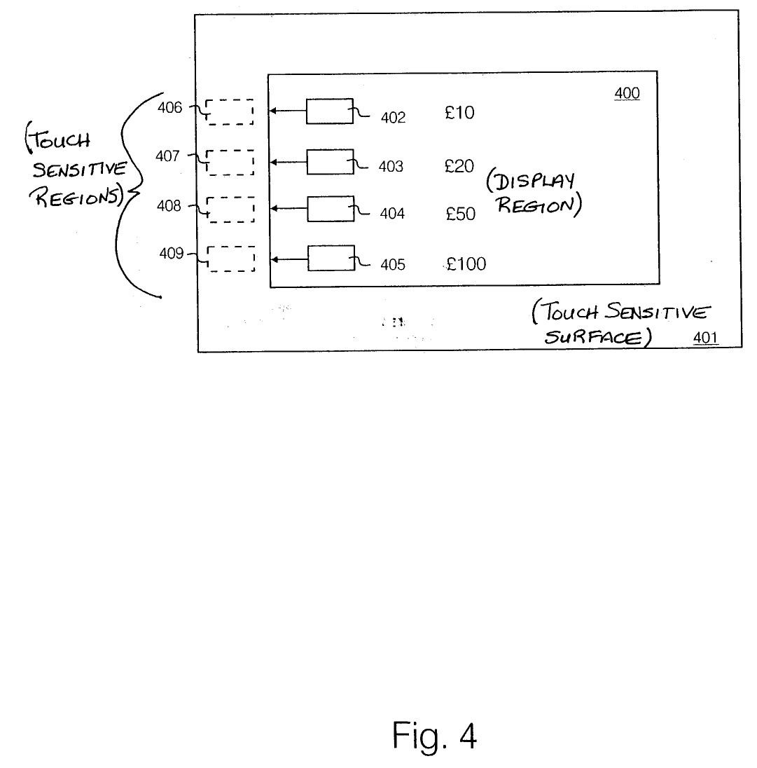

FIG. 4 is a schematic front view of a user interface according to first specific embodiment of the present invention. The user interface comprises a display region 400, for example a liquid crystal display (LCD) screen; and a touch sensitive surface 401, wherein the touch sensitive surface is arranged peripherally around an outer perimeter of the display screen, such that it does not overlay the display region, which is clearly visible without being obscured by the touch sensitive region. The display screen is configured and activated to display a plurality of icons 402-405 adjacent a plurality of corresponding respective touch sensitive regions 406409, which are under program control for receiving touch signals resulting from applied pressure from a pointer, to activate functions according to the dynamically generated display shown.

For example for the information displayed in FIG. 4, four display icons 402-405 are generated having text £10, £20, £50, £100 respectively, indicating amounts of 10, 20, 50 or 100 pounds of cash are provided by respectively touching the regions 406-409 respectively of the touch sensitive surface 401.

The touch sensitive surface 401 comprises a touch sensitive layer having a polymer membrane embedded with a grid including a plurality of mutually orthogonal conductor wires, arranged in rows and at least one column, whereby deformation of the polymer membrane causes contact between individual conductors at intersections between horizontal and vertical conductors, thereby enabling a one dimensional or two dimensional position at which pressure has been applied, to be sensed. Signals received from the grid of conductors are analyzed in a known way by a control program of a computer device utilizing the user interface, to determine which particular region of the touch sensitive layer has been touched. A program controlling the user interface matches the signal received from individual ones of the touch sensitive regions 406-409 with a corresponding respective icon 402-405, according to a display mode displayed on the display region 400.

The display of FIG. 4 is operated under program control, such that different display modes can be effected. The touch sensitive region 401 is configurable under program control such that different areas of the touch sensitive region can be reassigned to perform different functions.

The display of FIG. 4 is capable of adopting a plurality of different display modes. In each display mode, a different group of display icons, e.g., icons 402-405, is displayed and the touch sensitive regions, e.g., regions 406-409, on the touch sensitive surface 401 are configured in a corresponding respective sensing mode, to provide control for each of the functions represented by a display icon displayed in the display region 400.

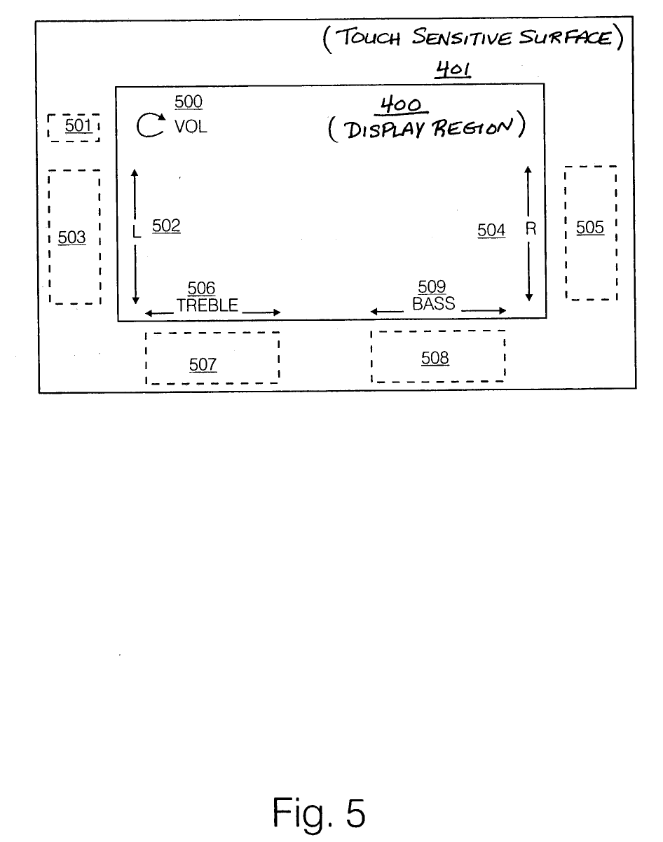

Referring to FIG. 5 herein, there is illustrated schematically display of a second set of information presented on the user interface described with reference to FIG. 4 and a second configuration of touch sensitive areas in a second mode of operation. The second mode of operation represents a mode of operation for controlling audio information, in which display region 400 displays a volume icon 500 comprising, a circular arrow volume icon, the volume icon 500 being displayed immediately adjacent a first touch sensitive region 501 of the touch sensitive surface 401. Touch sensitive region 501 occupies the same area on touch surface 401 as touch sensitive region 406. A left pan icon 502 is displayed in region 400 immediately adjacent a second touch sensitive region 503 on surface 401. The second touch sensitive region 503 is elongated such that a human user can draw a pointer along the second touch sensitive region, to operate the second touch sensitive region as a slider control for left speaker pan. Touch sensitive region 503 occupies the same area on surface 401 as regions 407-409. The computer associated with the interface of FIGS. 4 and 5 controls the functions of regions 406-409 relative to the functions of regions 501 and 503, respectively, in the same manner that the prior art computers control different functions associated with the same regions of the prior art touch sensitive screens that overlap displays. A right pan icon 504 is displayed on the display region 400 immediately adjacent to a third touch sensitive region 505 on surface 401. The third touch sensitive region 505 is elongated and of a shape suitable for a human user to draw a pointer along the third touch sensitive region to operate the third touch sensitive region as a slider control. A treble icon 506 is displayed on the display region 400, immediately adjacent a fourth touch sensitive region 507 on surface 401. The fourth touch sensitive region 507 is elongated and suitable for use as a slider control. A bass icon 509 is displayed on the display region 400 immediately adjacent a fifth touch sensitive region 508 on surface 401. The fifth touch sensitive region 508 is elongated and suitable for sliding a pointer along to provide a slider control for controlling audio bass.

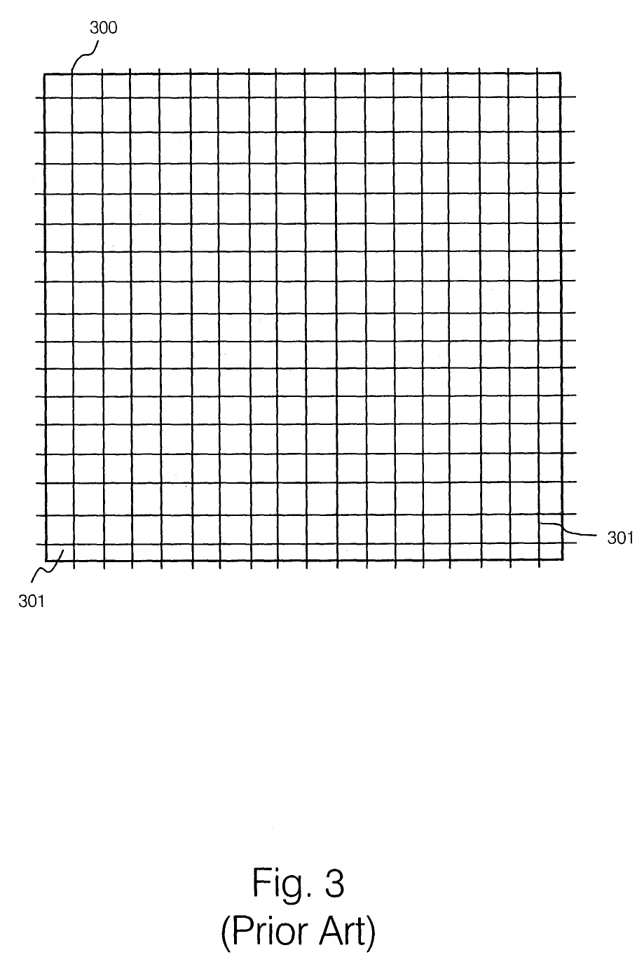

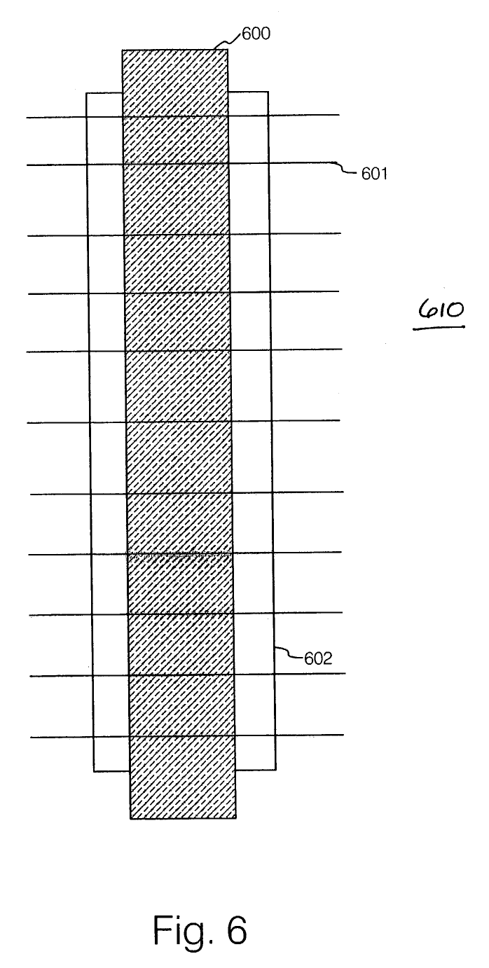

FIG. 6 is a schematic drawing of a pressure sensitive layer 610, suitable as a touch sensitive region of touch surface 401 capable of detecting one dimensional linear position of a pointer on surface 401. The touch sensitive layer 610 is similar to the prior art touch sensitive layer described with reference to FIG. 3 herein except that layer 610 includes a single column electrical conductor 600, and a plurality of row conductors 601, embedded in a clear polymer layer 602. Pressing the polymer layer 602 causes electrical contact between the single column conductor 600, and one or more row conductors 601, at the position where a pointer applies pressure.

Construction of a touch sensitive layer configured for detecting one dimensional position as shown in FIG. 6, has a reduced cost advantage compared to a prior art touch sensitive layer configured for detecting two dimensional position. For specific implementations of a user interface, where specific regions need to detect only one dimensional or zero dimensional (simple on/off) information, the one dimensional touch sensitive region has an advantage of a reduced cost interface compared to a touch sensitive region capable of two dimensional position detection. A user interface comprising a two dimensional touch sensitive region as described with reference to FIG. 3, can be configured to give one dimensional position data or two dimensional position data.

In the present disclosure, a two dimensional touch sensitive region has conductors arranged in plural rows and plural columns. However, there are other ways of making two dimensional touch sensitive regions which do not involve rows and columns, as known to those who are skilled in the art.

Similarly, for a one dimensional touch sensitive region, a plurality of conductors arranged in rows is only one implementation, and other implementations are possible. One such other implementation comprises a first single conductor arranged longitudinally in a strip, where the conductor has a high resistance, underlaid by a second conductor of lower resistance, with electric connection between the two conductors being at any position along the length, to form an electrical contact. Electric contact depends upon the length or position where the first conductor contacts the second conductor under pressure. Since the electric resistance of the first conductor varies in direct proportion with its length, measuring the resistance of the connection gives an indication of the position along the length of the conductor where contact is made. The two conductors are embedded in a polymer layer similarly as described herein.

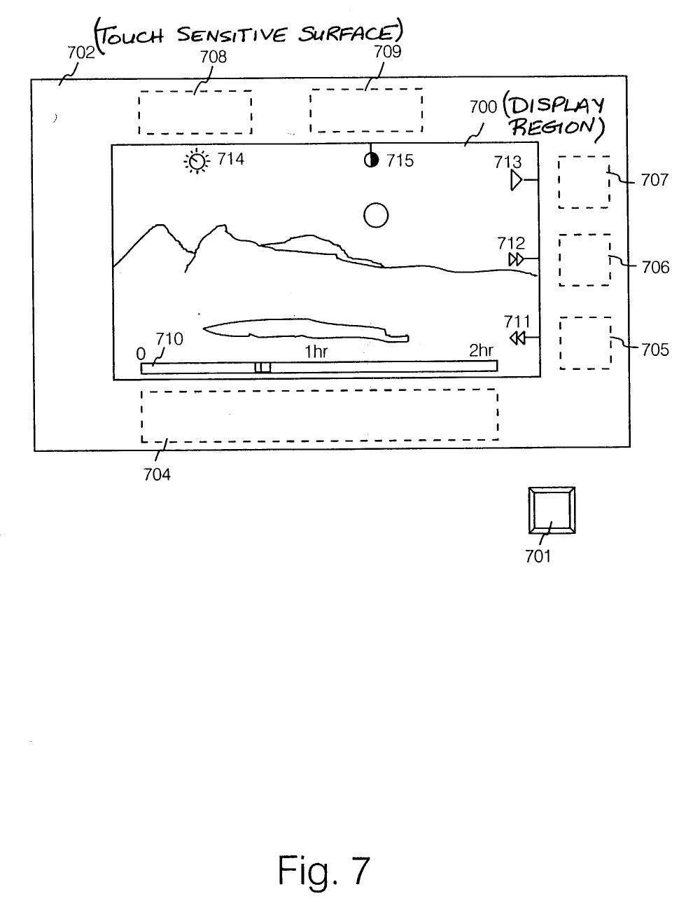

Referring to FIG. 7 herein, there is illustrated schematically the user interface in a third mode of operation, suitable for controlling video functions. In the third mode of operation, a plurality of display items are displayed on a centrally located display screen 700, which is configured for displaying video images. The plurality of display items are superimposed on the video image, thereby enabling the video image to occupy as large an area of the display screen 700 as possible. The display items are configured so as to appear upon activation of a meta-button 701 that is outside touch sensitive surface 702 and is an electronic switch. Pressing button 701 gives rise to a signal for controlling a 30 processor to generate and display the display items superimposed on the video image on screen 700. The display items can be made to appear or disappear by activating, i.e., pressing, meta-button 701.

Touch sensitive surface 702, positioned peripherally around the display region 700, is electronically configured into a plurality of touch sensitive regions 704-709. Each of touch sensitive regions 704-709 is situated adjacent a corresponding respective display item in display region 700, so that it is visually apparent and immediately intuitively apparent to a user, that activation of a function represented by a display item in display region 700 can be made by manipulation and touching of the respective pressure sensitive region on surface 702 positioned immediately adjacent that display item.

Display items in display region 700 and touch sensitive regions on surface 702 include:

a video position display item 710 in region 700 comprising an elongated ribbon and slider display de-marked with time settings, for example 0, 1 hour, 2 hour, representing a time within a video sequence or video film of the video images being displayed. The user, by drawing a pointer along first elongated touch sensitive region 704 on surface 702 immediately below and in alignment with item 710, can draw the slider display item backwards and forwards in time to control the position of play of video images within the video sequence;

a fast rewind icon 711 in region 700 placed adjacent a second pressure sensitive region 705 on surface 702. The second touch sensitive region 705 acts as an on/off switch for stopping and starting the rewind function. Activation of rewind function rewinds the video image displayed on the screen;

a fast forward icon 712 in region 700, represents a fast forward function, and is positioned adjacent a third pressure sensitive region 706 on surface 702. Pressing region 706 acts as an on/off signal for stopping and starting a fast forward video function;

a play icon 713 in region 700 is positioned immediately adjacent a fourth pressure sensitive region 707 on surface 702. Icon 713 acts as an on/off switch for activating a video play function;

a brightness display icon 714 in region 700 is displayed immediately

adjacent an elongated fifth pressure sensitive region 708 on surface 702. The fifth pressure sensitive region 708 acts as a slider control, such that by drawing a pointer from left to right or vice versa along the region, brightness of the video image is controlled to become brighter/darker; and

a contrast display icon 715 in region 700 is displayed immediately adjacent an elongated sixth pressure sensitive region 709 on surface 702. The sixth pressure sensitive region 709 is such that a pointer can be drawn from left to right and vice versa along the sixth pressure sensitive region in the manner of a slider control, thereby controlling the brightness of an image displayed on the display region 700.

Touch screen regions 704, 705 and 706 overlap regions of touch screen regions 507, 508 and 505 respectively. Display region 700 corresponds with display regions 400 of FIGS. 4 and 5, while touch sensitive surface 702 corresponds with touch sensitive surfaces 401 of FIGS. 4 and 5. Portions of images 506, 509 and 504 respectively occupy the same spaces in display region 400 as portions of images 710, 711 and 712 that occupy display region 700. The computer associated with the interfaces of FIGS. 4, 5 and 7 controls the functions of regions 704, 705 and 706 relative to the functions of regions 507, 508 and 505 respectively, in the same manner that the prior art computers control different functions associated with the same regions of the prior art touch sensitive screens that overlap displays. The computer also controls images 506, 509 and 504 that overlap images 710, 711 and 712 in the same manner that prior art computers activate different displays at different times.

Touching each of touch sensitive regions 704-709 with a pointer results in a signal being generated. Pressure sensitive regions can operate as simple on/off sensors; for example the fast rewind icon 711, fast forward icon 712 and play icon 713 correspond to the respective second, third and fourth pressure sensitive regions 705-707, which, in this mode of operation are configured as simple on/off switches. Activation of each of touch sensitive regions 705-707 gives rise to an electrical signal, which can be used by a controller, under program control, to generate a signal to cause the fast rewind, fast forward and play icons respectively, to modify slightly, giving a visual indication to the user, that activation of the appropriate function has been made within a device comprising the display, thereby given an intuitive visual feed back to the human user.

Similarly, drawing a pointer along the elongated first touch sensitive region 704, which is visually associated with the video position display item 710 presented in the form of a ribbon and slider display, causes a slider to move along the ribbon, on the display, as the pointer is drawn along the first touch sensitive region 704. An intuitive visual feedback is thereby given to a user, displaying in real time, a section of a movie, which a currently displayed video picture displayed on the screen display 700 occupies within an overall time 10 duration of the movie or video.

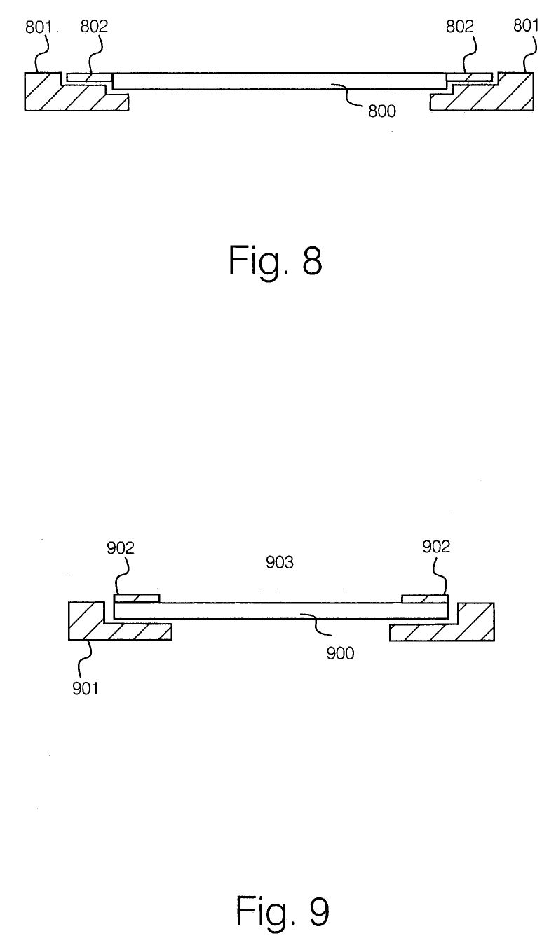

FIG. 8 is a side sectional view of a first construction of the user interface illustrated in FIGS. 4, 5 and 7. According to the first construction, display screen 800 (corresponding to display regions 400 and 700) is recessed within a casing 801 of a computer device such as a personal digital assistant (PDA) or an lectronic book. A touch sensitive sheet 802 (corresponding to touch sensitive surfaces 401 and 702) is positioned peripherally around and bonded to the display screen 800, so sheet 802 overlaps the casing 801. The touch sensitive sheet 802 does not overlap the display screen 800, thereby making maximum use of a relatively large area of the display screen, which is a relatively high cost item.

FIG. 9 is a side sectional view of a second construction of the user interface illustrated in FIGS. 4, 5 and 7. In the second construction, a substantially planar display screen 900 (corresponding to display regions 400 and 700) is positioned to be substantially flush with an outer surface of a casing 901 of a computer device into which screen 900 is fitted. A touch sensitive sheet 902 (corresponding to touch sensitive surfaces 401 and 702) is overlaid around a perimeter of the display screen 900, leaving exposed a central display area 903 which can be viewed without being obscured by the touch sensitive sheet 902. Display icons and/or menus are displayed in an obscured area of the display screen 900, and are referenced to individual touch sensitive regions of the touch sensitive sheet 902 in use.

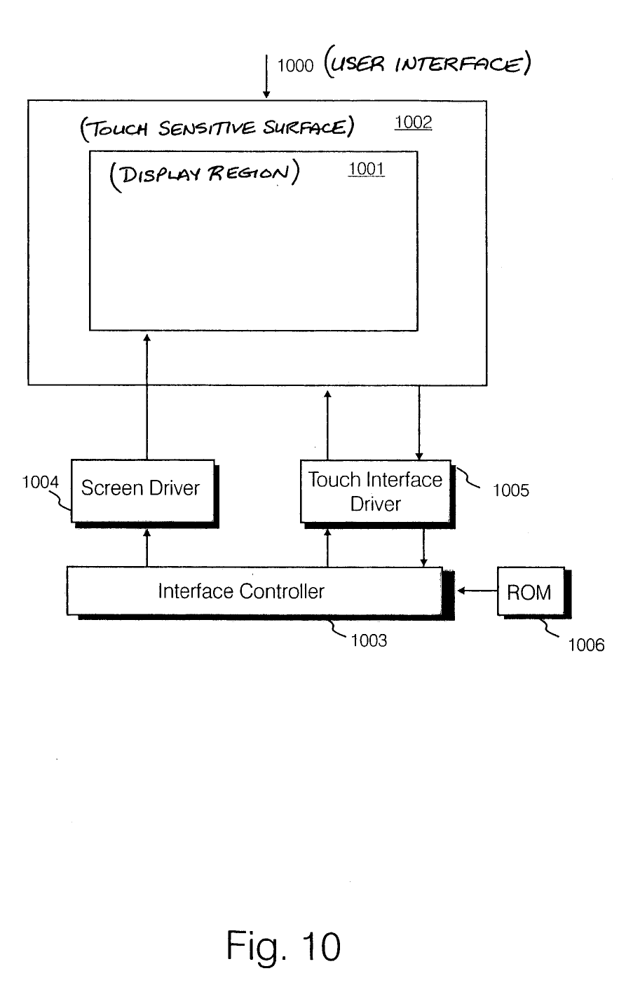

FIG. 10 is a block diagram of a control and drive of the user interfaces of FIGS. 4, 5 and 7. User interface 1000 (corresponding to the interfaces of FIGS. 4, 5 and 7) comprising a display region 1001 (corresponding to display regions 400 and 700) and touch sensitive surface 1002 (corresponding to touch 5 sensitive surfaces 401 and 702) is controlled by an interface controller 1003, which supplies instructions to screen display 1001 via a screen driver 1004, and which controls the touch sensitive surface 1002 through a touch interface driver 1005. The controller and touch interface driver 1005 has two functions:

firstly to configure the touch sensitive surface 1002 into a plurality of pressure sensitive regions, which correspond with a display mode displayed on the display region 1001; and

secondly, to receive signals from the configured pressure sensitive regions of surface 1002, and supply the received signals to the interface controller 1003.

Interface controller 1003 comprises a processor, operating in accordance with a set of program instructions stored in a memory device, for example read only memory (ROM) 1006.

Specific arrangements according to the present invention provide a device which offers a direct graphical user interface having similar functionality to a conventional touch screen, but without the need to directly touch a display screen, and therefore avoiding the need to obscure a display by a reflective and/or poorly light transmitting touch screen membrane. Instead, a touch sensitive area is positioned adjacent to a display device. A touch sensitive area may comprise one contiguous area, or a plurality of adjacent touch sensitive areas. The touch sensitive area or areas can extend around the periphery of a display device. In various embodiments, a display screen can indicate user options by making a visual display, wherein the user options can be activated by touching a touch sensitive area which does not overlap the display area. A user can touch, press, stroke or turn its finger or a touching device against the touch sensitive area, in order to achieve a function indicated by the display device.

An important and useful variation according to a further specific embodiment comprises a device in which a touch sensitive area around a display device comprises a plurality of touch sensitive areas that can be independently activated. Independent activation of different touch sensitive areas simultaneously results in operation of plural functions of a computer device simultaneously.

1. A user interface for a computer device, said user interface comprising:
a visual display for displaying a plurality of display items each representing a function of said computer device; and
a touch sensitive surface, said touch sensitive surface positioned relative to said display so as not to obscure a view of any of the display items on said display, said touch sensitive surface including a plurality of touch sensitive regions;
said touch sensitive regions and the computer device being arranged so the region can activate plural functions of said computer device represented by said display items.

2. The user interface of claim 1 wherein said touch sensitive surface includes touch sensitive areas corresponding with display items on the display, said display items and touch sensitive areas being arranged so that touch sensitive areas of the surface are in proximity with and non-overlapped in relation with the display items that correspond with the touch sensitive areas.

3. The user interface of claim 2, wherein one of the areas has a single dimension.

4. The user interface of claim 2 wherein the one of the areas is elongated and the corresponding display item is elongated and aligned with the elongated area; the elongated area, computer device and elongated display item being arranged so that movement of a pointer along the elongated area results in corresponding movement of the elongated digital display item.

5. The user interface of claim 1 wherein said one touch sensitive area is adjacent the display.

6. The user interface of claim 5 wherein said touch sensitive area substantially surrounds the display.

7. The user interface as claimed in claim 1, wherein said visual display and the computer device enable the display to adopt a plurality of different display modes, each said display mode being arranged for displaying a different group of said display items; and
said touch sensitive surface and the computer device enabling the touch sensitive surface to adopt a plurality of different sensing modes, wherein each said sensing mode corresponds to a respective one of said display modes of said visual said display.

8. The user interface as claimed in claim 1,
wherein individual ones of said touch sensitive regions of said touch sensitive surface control functions represented by corresponding respective individual ones of said display items for display on said display screen.

9. The user interface as claimed in claim 1 configured to provide a switch interface, said switch interface comprising:
a plurality of individual display items, each said display item representing an individual function which is suitable for selection by a binary switch, and
a plurality of said touch sensitive regions, each of said touch sensitive regions being configured as a binary switch, wherein each said touch sensitive region corresponds to at least one said respective display item.

10. The user interface as claimed in claim 1, configured for controlling a plurality of audio functions, said audio functions being at least two of:
a volume display item;
a left pan display item;
a right pan display item;
a treble display item;
a bass display item; and
said touch sensitive surface is partitioned into a plurality of said touch sensitive regions, said plurality of touch sensitive regions configured for controlling a function corresponding to the at least two audio functions.

11. The user interface as claimed in claim 1, configured as a video display wherein;
said visual display is configured to display a video sequence;
said visual display is configured to display a plurality of control icons for controlling video functions, said control icons including:
a brightness control icon;
a contrast control icon;
a play control icon;
a rewind control icon;
a forward control icon;
a position indicator icon for indicating a position of a video sequence displayed on said visual display within said video sequence; and
said touch sensitive surface is configured into a plurality of said touch sensitive regions, said touch sensitive regions being capable of controlling functions selected from the set:
brightness control;
contrast control;
a play control;
a forward control;
a rewind control; and
a position control for controlling the position of said displayed video images within said video sequence.

12. A method of controlling operation of a computer device, said method comprising the steps of:
during a first time interval:
(a) displaying a first display item in a display region of a display;
(b) applying pressure to a pressure sensitive region of a pressure sensitive surface, said pressure sensitive region being positioned away from a position of said display region where said display item is displayed on said display screen, such that said pressure sensitive region does not overlay said display region where said display item is displayed;
(c) in response to said pressure applied during the first interval, activating a first function of said computer device, represented by said first display item;
during a second time interval:
(a) displaying a second display item in a display region of the display;
(b) applying pressure to the pressure sensitive region of the pressure sensitive surface, and
(c) in response to said pressure applied during the second interval, activating a second function of said computer device, represented by said second display item.

13. A user interface for a computer device, said user interface comprising:
a display area for displaying a plurality of display items each representing a corresponding function of said computer device;
the at least one pressure sensitive region corresponding with at least one of said display items, the at least one pressure sensitive region and the computer being arranged for generating plural signals having different functions in response to a pressure input at said pressure sensitive region;
wherein said pressure sensitive region is spaced apart from a region of said display area occupied by said display item, such that said pressure sensitive region does not overlay said display item.

14. The user interface as claimed in claim 13, configured to provide a switch interface, said switch interface comprising:
a plurality of individual display items, each said display item representing an individual function which is suitable for selection by a switch; and
a plurality of said touch sensitive regions, each said touch sensitive region being configured as a switch, wherein each said touch sensitive region is located at a position corresponding to a said respective display item.

15. A user interface for a computer device, said user interface comprising:
a substantially flat display having a plurality of display regions, each of said display regions being capable of being electronically activated to display plural display items having different functions; and
a touch sensitive surface, said touch sensitive surface being positioned immediately adjacent a visible area of said display device, said touch sensitive surface comprising at least one touch sensitive region, said touch sensitive region and computer device being arranged for generating plural signals having different functions in response to an applied touch;
wherein said touch sensitive region is spaced apart from a region of said display device occupied by a said display item, such that said touch sensitive region does not overlay said display item.

16. A computer device comprising:
a user interface comprising a display area for display a plurality of display items each representing a corresponding function of said computer entity, and a touch sensitive surface, said touch sensitive surface comprising at least one touch sensitive region, said touch sensitive surface and computer device being arranged for generating plural signals having different functions in response to a touch input applied at said touch sensitive region;
a display driver for driving display of said plurality of display items in said display area;
a touch interface driver for driving said touch sensitive surface; and
at least one controller for controlling said display area and said touch sensitive surface to generate a plurality of display items displayed on said display area and a plurality of touch sensitive regions generated on said touch sensitive surface, wherein each said touch sensitive region provides plural functions corresponding with plural respective display items displayed on said display area.

17. The computer device as claimed in claim 16, wherein said user interface is arranged to provide a switch interface, said switch interface comprising:
a plurality of individual display items, each said display item representing an individual function which is suitable for selection by a switch; and
a plurality of said touch sensitive regions, each said touch sensitive region configured as a switch, wherein each said touch sensitive region is positioned corresponding to a said respective display item.

18. The computer entity as claimed in claim 16, wherein said controller is arranged to control said display and said touch sensitive surface such that:
said display adopts a plurality of different display modes, each of said display modes comprising a plurality of display items, each of said display items representing a function provided by a said computer entity; and
said touch sensitive surface having a plurality of sensing modes, wherein each of said sensing modes corresponds to a respective one of said display modes, in each of said sensing modes, said touch sensitive surface having a plurality of touch sensitive regions, each of said touch sensitive regions being arranged for controlling a function of said computer corresponding to a respective one of said display items in said corresponding respective display mode.

19. The computer device as claimed in claim 16, further including a program for controlling generation of said display items and said touch sensitive regions.

20. The computer device as claimed in claim 16, wherein;
said program and said touch interface driver are arranged for controlling said touch sensitive surface to provide a plurality of touch sensitive regions, each of said touch sensitive regions being capable of being activated independently of each of the other touch sensitive regions.

21. The computer device as claimed in claim 16, wherein said program and said touch interface driver are arranged to control said touch sensitive surface to provide a touch sensitive region capable of outputting a signal in response to a touch, wherein said signal indicates a position of an applied touch within said touch sensitive region.

22. The computer device as claimed in claim 16, wherein said program and said touch interface driver are arranged to control said touch sensitive surface to provide a touch sensitive region capable of outputting a rotational signal in response to an applied touch, wherein said signal indicates a position of said applied touch and a rotational movement of said applied touch within said touch sensitive region.

23. The computer device as claimed in claim 16, wherein said program and said touch interface driver are arranged to control said touch sensitive surface to provide a touch sensitive region capable of outputting a signal in response to a touch;
wherein said touch sensitive region is arranged to provide a signal having a value proportional to a position along a length of said touch sensitive region at which said touch sensitive region is touched; and
said program is arranged to control a slider display item to adopt a linear display position, said linear display position being proportional to a position of said touch input along said touch sensitive region.
